(19) United States
(12) Patent Application Publication
(10) Pub. No.: US 2007/0110317 A1
(43) Pub. Date: May 17, 2007

(54) Method of forming a reflective device

(75) Inventors: Timothy John Davis, Ivanhoe (AU); Robert Arthur Lee, East Burwood (AU); Lawrence David McCarthy, Noble Park North (AU); Gerhard Frederick Swiegers, Vermont South (AU); Gerard Joseph Wilson, Collingwood (AU)

Correspondence Address: LADAS & PARRY, 5670 WILSHIRE BOULEVARD, SUITE 2100, LOS ANGELES, CA, 90036-5679, US

(73) Assignee: COMMONWEALTH SCIENTIFIC AND INDUSTRIAL RESEARCH ORGANISATION, AUSTRALIAN CAPITAL TERRITORY 2612 (AU)

(21) Appl. No.: 10/562,278

(22) PCT Filed: Jul. 7, 2004
(86) PCT No.: PCT/AU04/00917

§ 371 Date: Oct. 26, 2006

(30) Foreign Application Priority Data
Jul. 7, 2003 (AU) 2003903501

(51) Int. Cl. G06K 9/48

(52) U.S. Cl. 382/199

(57) ABSTRACT

There is disclosed a method of forming a reflective device which generates an optically variable image which varies according to the angle of observation. The method comprises the steps of providing a primary pattern which encodes a latent image, the primary pattern having a plurality of image elements, and providing a corresponding secondary pattern which will decode the primary pattern to allow the latent image to be observed when the primary and secondary patterns are in at least one registration, wherein the secondary pattern is provided by a micro mirror array (MMA) having a plurality of each of at least two different types of micro mirror elements, wherein the primary pattern is provided such that predetermined image elements of the primary pattern render reflection effects from predetermined micro mirror elements of the MMA optically ineffective at least at one observation angle when the reflective device is illuminated with a light source to thereby enable the latent image to be observed.

The present invention claims priority of Australian provisional patent application 2003903501, the disclosure of which is incorporated herein by reference.

### FIELD OF THE INVENTION

The present invention relates to a reflective device. When reflective devices made in accordance with embodiments of the invention are illuminated by a light source, they generate one or more images which are observable within particular ranges of viewing angles around the device. Devices of embodiments of the invention may be used in a number of different applications, and have particular application as an anti-forgery security device on ID documents such as drivers licenses, credit cards, visas, passports and other valuable documents where secure identification of individuals is required in a way which is resistant to counterfeiting by printing, photocopying and computer scanning techniques.

Embodiments of the invention also have particular application as a low cost anti-counterfeiting device for the protection of banknotes, cheques, credit cards and other financial transaction documents such as share certificates.

### BACKGROUND ART

It is to be understood that, if any prior art publication is referred to herein, such reference does not constitute an admission that the publication forms a part of the common general knowledge in the art, in Australia or any other country.

The new series of American Express US dollar travellers cheques, first issued in 1997, employed as an anti-counterfeiting feature a diffraction grating foil image of the American Express Centurion logo. When illuminated by a light source and the diffraction grating foil device is observed from different viewing angles, the Centurion image appears to switch to an American Express box logo image. This optical variability of the device ensures that it is impossible to copy by normal photocopier or camera techniques.

Diffraction grating devices which exhibit this variable optical behaviour are referred to as optically variable devices (OVDs) and their use as an anti-counterfeiting measure to protect valuable documents is continuing to grow. Examples of particular proprietary optically variable devices and applications to date include the EXELGRAM™ device used to protect the new series of Hungarian banknotes, American Express US dollar and Euro travellers cheques and the Ukrainian visa, and the KINEGRAM™ device used to protect the current series of Swiss banknotes and low denomination Euro banknotes. The EXELGRAM™ device is described in U.S. Pat. Nos. 5,825,547 and 6,088,161 while the KINEGRAM™ device is described in European patents EP 330,738 and EP 105099.

The KINEGRAM™ and EXELGRAM™ devices are examples of foil based diffractive structures that have proven to be highly effective deterrents to the counterfeiting of official documents. This class of optically diffractive anti-counterfeiting devices also includes the PIXELGRAM™ device that is described in European patent number EP 0 490 923 B1 and U.S. Pat. No. 5,428,479. PIXELGRAM™ devices are manufactured by producing a counterpart diffractive structure wherein the greyness values of each pixel of an optically invariable image are mapped to corresponding small diffractive pixel regions on the PIXELGRAM™ device.

An alternative technique for producing an OVD is to use a micro mirror array structure for the direct printing of an optically variable device without the use of hot stamping foil. The use of micro mirror arrays for the direct printing of optically variable images is described in International Patent Application No. PCT/AU02/00551 entitled “An Optical Device and Methods of Manufacture”.

In spite of their industrial effectiveness, these foil based diffractive and reflective optically variable devices have a particular deficiency for low volume applications and for one-off applications requiring secure identification of the images of individuals such as for the case of passport or drivers license photographs or identification (ID) card images.

At the present time techniques for protecting an individual portrait image on an ID document using a diffractive OVD include the origination of an OVD image specific to that individual, covering the photograph of the person with a transparent OVD laminate or film or including a standard OVD image on the ID document in an adjacent area of the document. In the first case the process is extremely expensive and time consuming because of the need to produce a new OVD origination for each individual and then produce a hot stamping foil image by embossing techniques. As the cost of OVD originations for security purposes varies from US$5,000 to US$50,000, depending on the technology type and level of security required, the use of individual specific OVD originations for ID applications is not viable for cost reasons alone.

Generally speaking, the high cost of OVD originations means that this type of anti-counterfeiting technology is only suited to mass production applications where the cost of the origination can be amortized over a large production run of identical hot stamping foils. The use of transparent OVD overlay films and the use of a generic OVD image are methods currently employed for amortizing the OVD origination cost over a foil production run for ID applications. However, in these cases the transparent overlay film or OVD image is not specific to the individual and therefore there is a risk that a substitute or counterfeit document could be produced by peeling back the transparent film and replacing the original photographic image by a substitute image to allow a different individual the use of the ID document.

Another technique which has been developed for security of applications is known as Screen Angle Modulation, “SAM”, or its micro-equivalent, “μ-SAM”, is described in detail in U.S. Pat. No. 5,374,976 and by Sybrand Spannenberg in Chapter 8 of the book “Optical Document Security, Second Edition” (Editor: Rudolph L. van Renesse, Artech House, London, 1998, pages 169-199). In this technique, latent images are created within a pattern of periodically arranged, miniature short-line segments by modulating their angles relative to each other, either continuously or in a clipped fashion. While the pattern appears as a uniformly intermediate colour or grey-scale when viewed macroscopically, a latent image is observed when it is overlaid with an identical, non-modulated pattern on a transparent substrate.

As noted above, these techniques involve overlaying a modulated array with the corresponding unmodulated array, or vice versa, in order to reveal the latent image.

The modulated and unmodulated arrays of this technique are usually produced by printing techniques. For this reason, this technique is not as secure as a diffractive OVD because it is more easily reverse engineered than the much smaller scale microstructures of a diffractive OVD.

It would be desirable to provide an alternative method of producing an authentication device.

### SUMMARY OF THE INVENTION

In a first broad aspect, the invention relates to a method of forming a reflective device which generates an optically variable image which varies according to the angle of observation, the method comprising the steps of:

providing a primary pattern which encodes a latent image, the primary pattern having a plurality of image elements; and

providing a corresponding secondary pattern which will decode the primary pattern to allow the latent image to be observed when the primary and secondary patterns are in at least one registration, wherein the secondary pattern is provided by a micro mirror array (MMA) having a plurality of each of at least two different types of micro mirror elements,

wherein the primary pattern is provided such that predetermined image elements of the primary pattern render reflection effects from predetermined micro mirror elements of the MMA optically ineffective at least at one observation angle when the reflective device is illuminated with a light source to thereby enable the latent image to be observed.

In some embodiments, the primary pattern is provided by being overlaid on the secondary pattern.

In still further embodiments, the primary pattern is provided by being printed in register with the secondary pattern.

In other embodiments, the primary pattern is provided by rendering the micro mirror elements optically ineffective. Depending on the embodiment micro mirror elements may be rendered optically ineffective by physically removing them (e.g. laser ablation), or by reducing its ability to reflect so that it does not reflect strongly.

The two types of micro mirror elements will typically be provided in a regular pattern. Typically, the regular pattern is provided by arranging at least two types of micro mirror elements into either pixellated or track-like pattern. An example of pixellated pattern is a checkerboard pattern, where a plurality of two different types of micro mirror elements are arranged in a rectangular array so that they alternate in each of the horizontal and vertical axes.

Herein, the micro mirror elements are rendered “optically ineffective” in the sense that reflection effects from these pre-selected elements are either eliminated or greatly reduced in terms of the intensity of the reflected light from these element relative to the other micro mirror elements.

The method may further include the steps of producing the micro mirror elements by:

I) producing a variable transparency photomask by electron beam lithography and wet or dry etching techniques;

II) using the photomask in an optical contact printing or projection system to create a surface relief pattern of two types of interlaced micro mirror structures arranged in a desired pattern;

III) producing a printing plate embossing die by the use of electroplating techniques applied to the created micro mirror array structure; and

IV) applying ink to a paper or polymer substrate using screen printing techniques and embossing the micro mirror array structure into the inked substrate.

In an embodiment, where the primary pattern is provided by being overlaid on the secondary pattern, the primary pattern is provided upon a transparent substrate, and the secondary pattern is provided in the form of an embossed substrate and the method involves aligning the primary pattern with the OVD secondary pattern in correct register such that the image elements of the latent image encoded in the primary pattern render micro mirror elements of the secondary pattern optically ineffective.

In a further aspect of the invention, the micro mirror elements are additionally encoded to produce a secure generic optical variability effect and the overlay ID screen or primary pattern is encoded with image information specific to a particular individual in such a way that the image of the individual disappears upon delamination of the film from the document. This embodiment greatly enhances ID security over present OVD lamination techniques because neither the OVD substrate nor the encoded overlay screen are open to modification using current photographic or printing techniques.

In an embodiment of the invention where the primary pattern is printed, the primary pattern is directly printed on top of the previously embossed printed generic OVD micro mirror array (MMA) substrate thereby providing increased security by preventing reverse engineering of the MMA and overlay screen interface by delamination.

In a further alternative embodiment of the invention where the micro mirror elements are altered, the primary pattern is directly incorporated into the OVD MMA by laser heating of the embossed MMA so as to destroy particular micro mirror elements at selected locations within the OVD area determined by the primary pattern data file. This implementation of the invention improves both the durability of the ID image over the previous alternative direct printing method because there is no possibility of erasing the encoded image information from the surface of the emboss printed MMA.

A number of techniques may be used to produce appropriate primary and secondary patterns. These techniques share the feature of producing a modulated array of image elements which encodes a latent image (the “primary” pattern) and a corresponding unmodulated array of image elements (the “secondary” pattern) which will decode the latent image when in register with the unmodulated array. As both the modulated and unmodulated arrays are divided into a plurality of discrete image elements, it is appropriate to refer to the modulated and unmodulated arrays as “digital” images. Accordingly, techniques of this type are collectively referred to herein as “modulated digital images” (MDI). Examples of suitable MDI techniques include SAM, μ-SAM, as well as PHASEGRAM, BINAGRAM, and TONAGRAM.

PHASEGRAMS are described in International patent application no. 2003905861 entitled “Method of Encoding a Latent Image”, filed 24 Oct. 2003 for which a PCT application was filed on 7 Jul. 2004 entitled “Method of encoding a latent image”. In this technique, an image is encoded within a locally periodic pattern by selectively modulating the periodicity of the pattern. When overlaid upon or overlaid with the original pattern on a transparent substrate, the latent image or various shades of its negative becomes visible to an observer depending on the exactness of the registration.

BINAGRAMS are described in International Patent application no. PCT/AU2004/00746 entitled: “Method of Encoding a Latent Image”, filed 4 Jun. 2004. In this technique, an image is divided into pairs of adjacent or nearby pixels, which may be locally periodic or not. One of the pixels in each pair is then selectively modulated to the complementary grey-scale or colour characteristic. When overlaid upon or overlaid with an equivalent non-modulated pattern on a transparent substrate, the latent image or its negative becomes visible depending on the extent of registration.

The primary pattern, as defined in this specification, will typically be a modulated version of the secondary pattern. The primary pattern encodes or incorporates a latent image or images; these are revealed only when the primary pattern is overlaid upon the corresponding secondary pattern (in the form of an OVD in embodiments of the present invention). The image elements employed in the primary pattern are typically pixels (i.e. the smallest available picture element). Typically, the primary pattern will be rectangular and hence its image elements will be organised in a rectangular array. However, the image elements may be arranged in other ways. Image elements will typically be arrayed in a periodic fashion, such as alternating down one column or one row, since this allows the secondary pattern to be most easily registered with the primary pattern in overlay. However random or scrambled arrangements of image elements may be used.

In this specification, the term “secondary pattern” is used in two contexts, either describing a pattern which will decode a primary pattern when overlying or overlaid by the primary pattern (depending on the nature of the primary pattern) or to describe such a secondary pattern as applied to a substrate. When the secondary pattern is applied to form an array of micro mirror elements (a micro mirror array (MMA)) as described in this specification, the secondary pattern consists of micro mirror elements which correspond to the image elements which either effectively reflect light (“on” micro mirror elements) or reflect light ineffectively (“off” micro mirror elements) at a particular angle of observation. These micro mirror elements are arrayed in the pattern of the secondary pattern which also corresponds to the primary pattern employed to encode the latent image. The physical dimensions of the micro mirror elements in the physical secondary pattern are, moreover, substantially identical to those of the image elements of an secondary pattern image which corresponds to the primary pattern employed. The “on” and “off” micro mirror elements are arrayed in such a way that when illuminated with a light source, they contrast image elements within the primary pattern that reveal the latent image, or an image related thereto. The optical variability of the device is achieved when the angle of view is changed to other specific angles of view and all of the “off” micro mirror element convert to “on” pixels and vice versa. To achieve the required contrast it is necessary that all of the “on” micro mirror elements at any specific angle of observation must reflect light, while all of the “off” pixels do not reflect light at this angle.

The secondary pattern will typically be a regular array of “on” and “off” micro mirror elements. For example, a secondary pattern may be “track-like”, that is, a rectangular array consisting of a plurality of vertical lines of “on” micro mirror elements, each line being 1 micro mirror element wide and separated by identically wide vertical lines of “off” micro mirror elements. Another typical secondary pattern may be a checkerboard of “on” and “off” micro mirror elements. Random and scrambled arrays may, however, also be used, so long as the “on” micro mirror elements in the secondary pattern are capable, when in correct register, of contrasting all of the image elements in the primary pattern which reveal the latent image.

The secondary pattern is also referred to in the present specification as the “background OVD” or “background MMA”.

Another technique which may be used to create a primary pattern from a secondary pattern is known as TONAGRAM and described in Australian Provisional Patent application 2004900187 entitled “Method of Concealing an Image” filed 17 Jan. 2004.

In this technique, an MDI, such as a BINAGRAM or a PHASEGRAM is mathematically combined with an overt image, such as a photographic portrait, to thereby render a primary pattern which contains both the overt image and one or more concealed latent images. When overlaid with the corresponding secondary pattern, the latent images are revealed. In the same way, a secondary pattern consisting of a micro mirror array of the type described in this application may be overlaid with a printed TONAGRAM primary pattern, thereby rendering an OVD containing an overt image which is visible at all angles of observation and which contains one or more latent images which are visible only at selected angles of observation. Alternatively, a blank canvas micro mirror array which serves as the secondary pattern may be rendered optically ineffective in selected areas according to a TONAGRAM algorithm. An OVD containing an overt image which is visible at all angles of observation and which contains one or more latent images which are visible only at selected angles of observation is thereby created.

The invention also extends to a reflective device, such as a reflective authentication device or a novelty item produced by the foregoing method as well as to documents or instruments incorporating a reflective device.

In another broad aspect, the invention relates to a reflective device which generates an optically variable image which varies according to the angle of observation, the reflective device comprising:

a primary pattern which encodes a latent image, the primary pattern having a plurality of image elements; and

a corresponding secondary pattern which will decode the primary pattern to allow the latent image to be observed when the primary and secondary patterns are in at least one registration, wherein the secondary pattern is provided by a micro mirror array (MMA) comprising a plurality of each of at least two different types of micro mirror elements, and

wherein the primary pattern is provided such that the predetermined image elements of the primary pattern render reflection effects from predetermined micro mirror elements of the MMA optically ineffective at least at one observation angle when the authentication device is illuminated with a light source to thereby enable the latent image to be observed.

As outlined above, a micro mirror array, patterned in the arrangement of a MDI secondary pattern by using two types of micro mirror elements in place of a printed MDI pattern, can be masked by the corresponding MDI primary pattern to generate the MDI latent image in the form of a unique, OVD effect. The resulting hybrid OVD-MDI, referred to here as an MM-VOID (or “Micro Mirror Variable Optical Identification Device”), displays optically variable properties which are difficult to counterfeit, but is nevertheless easily customised because the primary pattern can be readily printed and the OVD-based secondary pattern can be mass produced in a generic form.

Embodiments of the present invention therefore provide a more general and useful approach to the protection of images on security documents by separating the optically variable and identification aspects of the image in such way that the two aspects can be manufactured separately and recombined in an overlay manner. In other words, the present invention incorporates the OVD protection into a generic type of reflecting OVD micro mirror array (MMA) which is emboss printed onto a document to be protected and this MMA is then overlaid either with a transparent film containing the encoded ID information or printed in register with the ID information pattern. The combination of these two effects reveals the encoded image as a latent image displaying OVD effects.

Furthermore, in embodiments of the invention the use of a printing or embossing technique to produce the MMA in the preferred embodiment is firstly very cost-effective and secondly allows the MMA to be produced locally. The improves security as it is not necessary to transport material incorporating the MMA.

Further features of the invention will become apparent from the following description of preferred embodiments of the invention.

### BRIEF DESCRIPTION OF THE DRAWINGS

The preferred embodiments will be described with reference to the accompanying drawing in which:

FIG. 1 depicts a particular arrangement of the background MMA or secondary pattern;

FIG. 2 shows another arrangement of the background MMA or secondary pattern;

FIG. 3 shows an example of a primary Pattern corresponding to a particular ID application;

FIG. 4 shows the primary pattern of FIG. 3 added to the background MMA (secondary pattern) corresponding to FIG. 2;

FIG. 5 shows the image generated by the overlaid primary and secondary pattern of FIG. 4 observed at a particular angle of view;

FIG. 6 shows the image generated by the overlaid primary and secondary patterns of FIG. 4 observed at another particular angle of view;

FIG. 7 shows an example of a primary pattern;

FIG. 8 shows the primary pattern of FIG. 7 added to the background OVD MMA (secondary pattern) corresponding to FIG. 1;

FIG. 9 shows the image generated by the overlaid primary and secondary patterns of FIG. 8 observed at another particular angle of view;

FIG. 10 shows the image generated by the overlaid primary and secondary screens of FIG. 8 observed at a particular angle of view; and

FIG. 11 shows a micrograph of a small section of a MMA.

### FURTHER DESCRIPTION OF THE DRAWINGS

Preferred embodiments of the invention will initially be described in relation to the visual effects which can be produced by combining an MDI primary pattern with a secondary pattern in the form of a micro mirror array. Following this description is a description of some possible techniques for constructing reflective authentication devices.

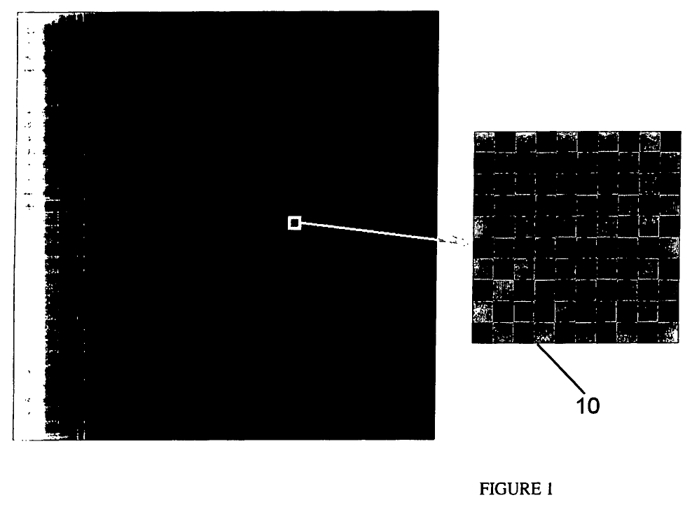

FIG. 1 is an illustrative example of a background MMA (or secondary pattern). In FIG. 1, the pixel areas having different shades represent two different types of reflecting micro mirror elements as best seen in enlarged section 10. For convenience these shades will be referred to as red (the lighter shade) and blue (the darker shade) pixel areas. Typical dimensions of the micro mirror pixel areas would be 30 microns×30 microns or 60 microns×60 microns. For some applications the dimensions of the pixels may be smaller or larger than these figures depending on the image resolution required for the application.

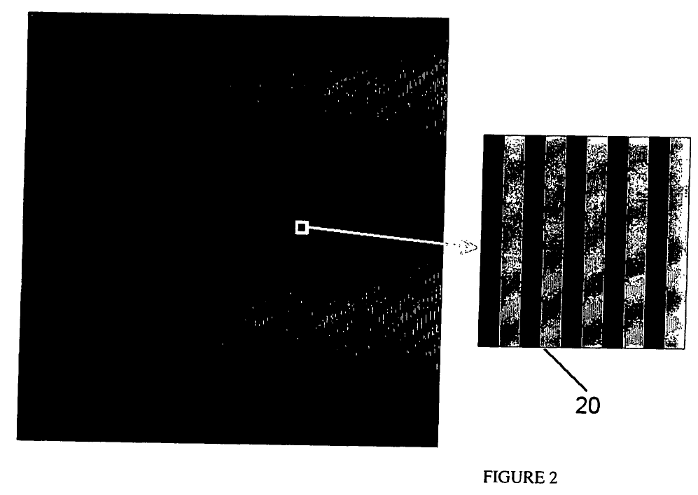

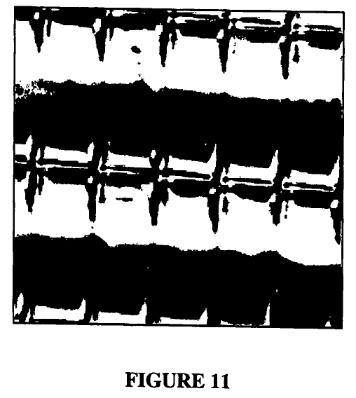

FIG. 2 shows another arrangement of the background OVD microstructure or secondary pattern. In FIG. 2 the red and blue strip or track areas represent two different types of MMA as best seen in enlarged section 10. Typically the width of the tracks would be 30 microns or 60 microns. For some applications the width of the strips or tracks may be smaller or larger than these figures depending on the image resolution required for the application. The length of the tracks is a function of the image area required for the application and may be 20 mm or longer. The maximum depth is typically 20 mm as illustrated by the micrograph of FIG. 11, where the micro mirror elements have two different slopes.

The choice of MDI secondary pattern will depend on the embodiment.

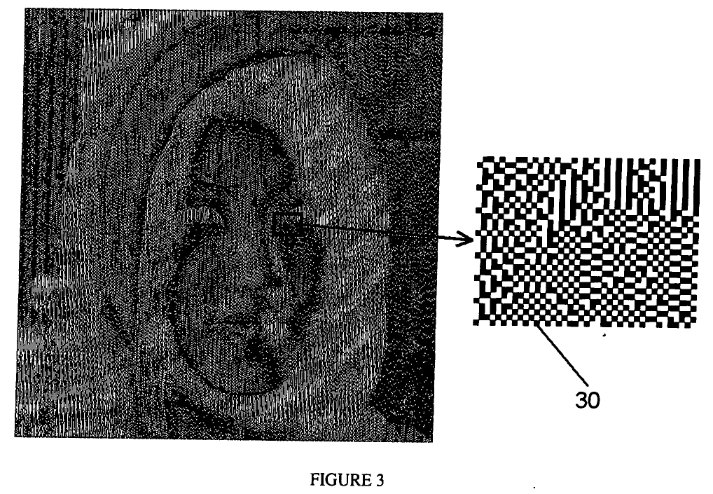

FIG. 3 shows a primary pattern of a first preferred embodiment into which an image has been encoded by modulation of the secondary pattern shown in FIG. 2. The method of forming the modulated digital image (MDI) is that of a BINAGRAM.

In a BINAGRAM, the primary pattern is typically formed from an original image. In an example where the original image is a photograph, this original image is then dithered into image elements which have one of a set of primary visual characteristics. The primary visual characteristics will be grey-scale values or hues depending on the embodiment. The original elements are then paired, typically with a neighbouring image element.

In the example of a preferred embodiment, the image elements are paired such that when overlaid with the corresponding secondary pattern, one element in each pair will correspond to the red track and one will correspond to the blue track. The image elements are then transformed. In a typical transformation, one pixel in each pair will take the average value of the visual characteristics of the pair and the other pixel is allocated a complementary visual characteristic. Thus, one pixel in each pair acts to carry information from the original image while the other disguises the information.

An alternative method of forming the primary pattern is to use a computer graphics program such as Adobe Photoshop to produce both positive tone and negative tone versions of an original image such as a portrait image. The positive tone and negative tone images can then be combined into a primary pattern by; firstly filtering the positive tone image with the “on” pixels of the secondary screen (that is removing all pixels from the positive tone image corresponding to the positions of the “off” pixels on the secondary screen) and then converting the resultant filtered positive tone image to a bitmap version by using the dithering option within the computer graphics program; secondly applying the reverse procedure to the negative tone image by filtering the negative tone image with the “off” pixels of the secondary pattern (that is removing all pixels from the negative tone image corresponding to the positions of the “on” pixels on the secondary screen) and then converting the resultant filtered negative tone image to a bitmap version by using the dithering option within the computer graphics program; and finally overlaying the filtered and dithered versions of both the negative tone and positive tone images to obtain the resultant primary pattern version of the input portrait image.

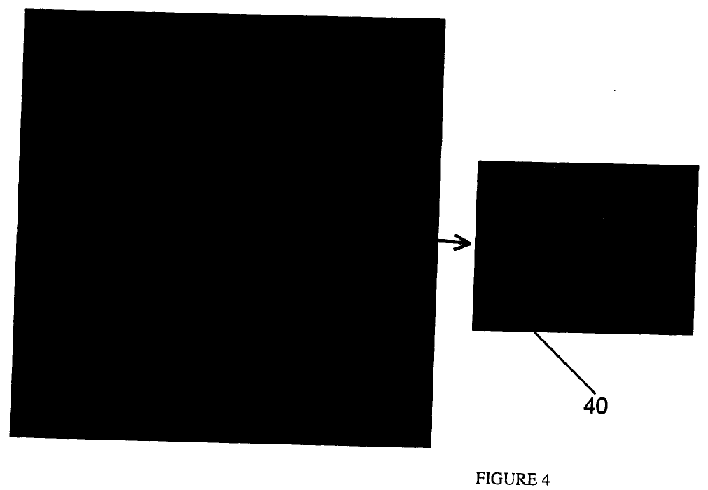

FIG. 4 shows a simple addition of the primary image in FIG. 3 to the secondary pattern in FIG. 2 where the black pixels have been rendered optically ineffective by being erased, the dark grey pixels indicate the original blue pixels which have been retained, and the light grey pixels indicate the original red pixels which have been retained as can best be seen by reference to enlarged section 40.

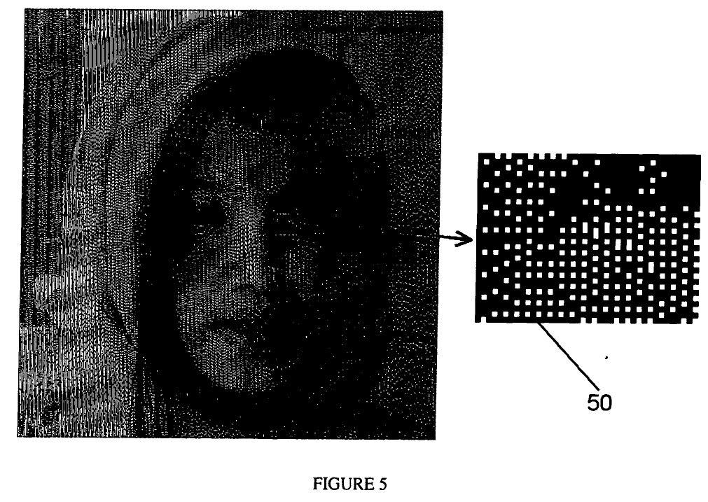

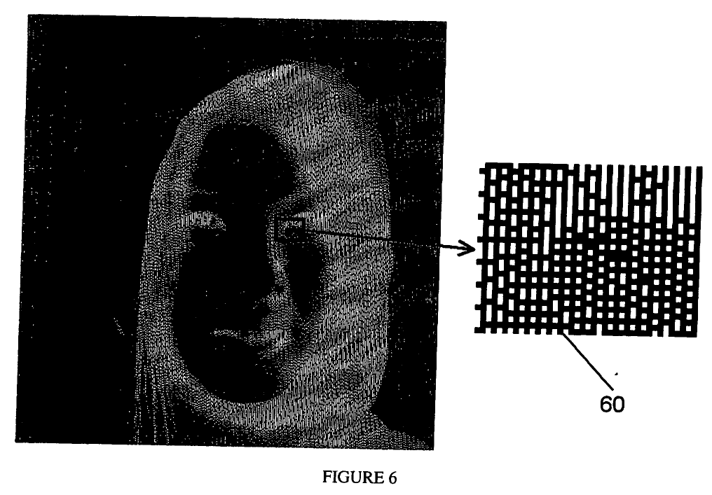

FIG. 5 depicts the image seen by an observer at one particular range of viewing angles with the red OVD tracks “on” and therefore displayed as white for clarity; the blue pixels are “off” at this angle and therefore appear black as best seen in enlarged section 50. FIG. 6 depicts the image seen by an observer at another particular range of viewing angles with the blue tracks “on” and therefore displayed as white for clarity; the red pixels are “off” at this angle and therefore appear black as best seen in enlarged section 60.

FIGS. 5 and 6 demonstrate that an optically variable effect can be generated by printing techniques if the background canvas is comprised of an OVD MMA consisting of two groups of micro mirror elements (that is, the secondary pattern). The OVD effect shown in these figures corresponds to a switch of a portrait image from positive tone to negative tone as the angle of view is changed.

This principle of using a background OVD canvas to convert a printed image into optically variable form can be extended to the case of two-channel OVD images. An example of such a process is now described.

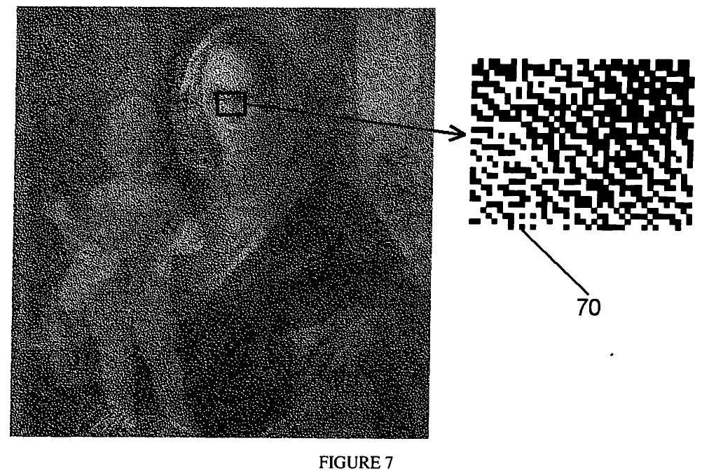

FIG. 7 depicts a primary pattern consisting of a two-channel image. In this case, the primary pattern is a modulated form of the secondary pattern shown in FIG. 1 and encodes two separate latent images. Enlarged portion 70 shows a detail of where the two faces of the images overlap.

A primary pattern corresponding to a two channel image can also be prepared using a computer graphics program such as Adobe Photoshop. Two original input images can be combined into a primary pattern by; firstly filtering the first image with the “on” pixels of the secondary screen (that is removing all pixels from the first image corresponding to the positions of the “off” pixels on the secondary screen) and then converting the resultant first image to a bitmap version by using the dithering option within the computer graphics program; secondly applying the reverse procedure to the second image by filtering the second image with the “off” pixels of the secondary pattern (that is removing all pixels from the second image corresponding to the positions of the “on” pixels on the secondary screen) and then converting the resultant filtered second image to a bitmap version by using the dithering option within the computer graphics program; and finally overlaying the filtered and dithered versions of both the first and second images to obtain the resultant two channel primary pattern corresponding to the two input images.

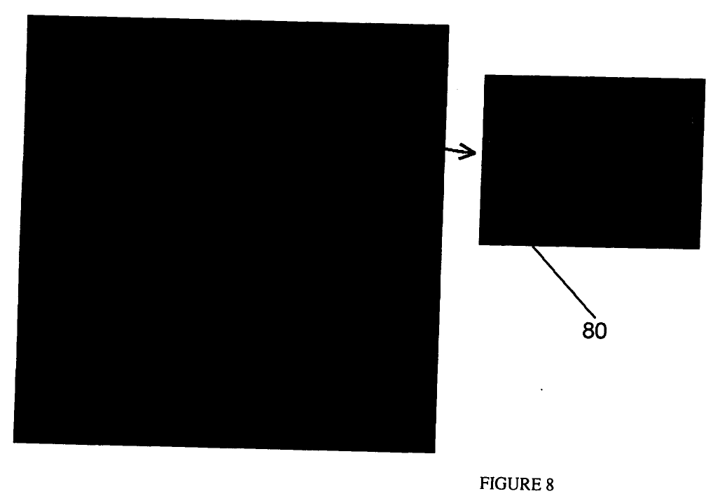

FIG. 8 illustrates an addition of FIG. 7 and FIG. 1 where the black pixels have been rendered optically ineffective by being erased, the dark grey pixels indicate the original blue pixels which have been retained, and the light grey pixels indicate the original red pixels which have been retained as best seen in enlarged portion 80.

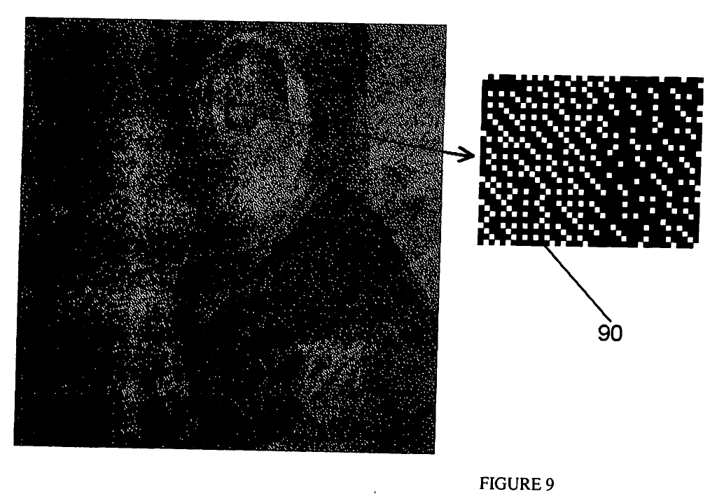

FIG. 9 depicts the image seen by an observer at one particular range of viewing angles with the red OVD pixels “on” and therefore displayed as white for better clarity; the blue pixels are “off” at this angle and therefore appear black as shown in enlarged portion 90.

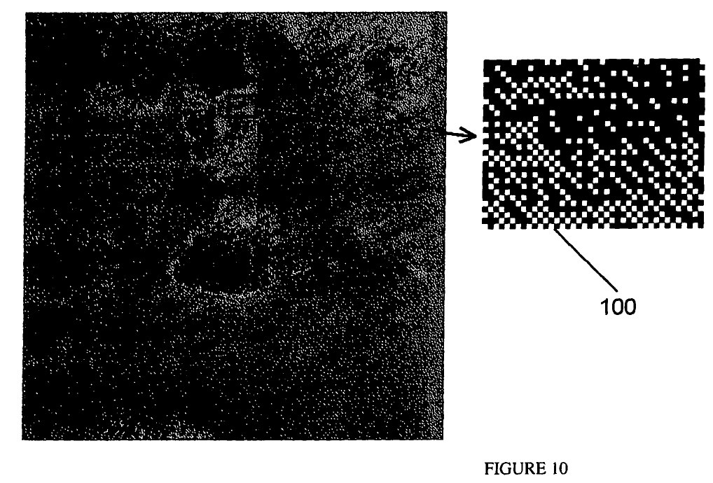

FIG. 10 depicts the image seen by an observer at another particular range of viewing angles with the blue tracks “on” and therefore displayed as white for better clarity; the red pixels are “off” at this angle and therefore appear black as shown in enlarged portion 100.

FIGS. 9 and 10 confirm that a two channel optically variable effect can also be generated by printing techniques if the background canvas is comprised of an OVD MMA consisting of two groups of micro mirror elements (that is, the secondary pattern). The OVD effect shown in these figures corresponds to a switch from one positive tone portrait image to another positive tone portrait image as the angle of view is changed.

The examples shown in FIGS. 1 to 10 are intended to illustrate two particular embodiments of the new invention. Many other embodiments of the invention are possible and the generality of these applications makes the invention particularly suited to the areas of identity verification for ID documents and also for the authentication of banknotes, cheques and other financial transaction documents which suffer from a risk of counterfeiting by printing, computer scanning, and colour copying techniques.

A further embodiment of the invention can be realised by recognising that the two channel mechanism described above allows for the possibility of encoding data in an individual manner by using bar code patterns for the images in the two channels. The result will be in the form of a micro mirror bar code with the first bar code pattern able to be read by a laser at a first angle of view and the second and different bar code pattern read at a second angle of view. The security and integrity of the data is ensured by a software correlation process involving the two bar code components. Writing of the data is achieved by a printing process involving the interlacing of the two bar codes on a reflecting micro mirror background in the form of an interlacing of micro mirror tracks of two different mirror angles.

The concepts described above can also be extended to include the case of a two channel image where the image in one channel is a generic image fixed at the time of fabricating the secondary pattern microstructure. The second channel image is then constructed by using a computer graphics program to create a primary pattern that can be individualised at the point of use of the device. An example of this type of application would be a passport application. In the case of an Australian passport the generic image could be the Coat of Arms of Australia and the second channel image would be a portrait image of the passport holder and the device could be incorporated into the data page of the passport. As the angle of view of the data page is changed the image generated by the authentication device would change from an image of the passport holder to the Coat of Arms thereby securely confirming that the passport holder is a citizen of Australia.

One method of forming a reflective authentication device in accordance with the invention involves the steps of:

I) Producing a variable transparency photomask by electron beam lithography and wet or dry etching techniques.

II) Using the photomask in an optical contact printing or projection system to create a surface relief pattern of two types of interlaced micro mirror structures arranged in a pixellated (e.g. FIG. 1) or track-like (e.g. FIG. 2) configuration.

III) Producing a printing plate embossing die by the use of electroplating techniques applied to the created micro mirror array structure.

IV) Applying ink to a paper or polymer substrate using screen printing techniques and embossing the micro mirror structure into the inked substrate by embossing techniques to produce an array of micro mirror elements.

V) Encoding one or more images which will be visible as the latent image (e.g. of a specific person, and/or object, or design) into a pixellated or track based primary pattern having a plurality of image elements which correspond to the secondary pattern; and

VI) adding a physical representation of the primary pattern on top of the micro mirror array background OVD in such a manner that pre-selected areas of the background microstructure are rendered optically ineffective in the sense that reflection effects from these pre-selected regions are either eliminated or greatly reduced in terms of the intensity of the reflected light from these regions. The position and area of each pre-selected ineffective region being determined from the primary pattern.

Typically where the secondary pattern is track-like, each track has a width greater than 1 micron and it is typical that at least one track is greater than 1 mm in length.

Where the secondary pattern is a pixellated array or micro mirror element each micro mirror element typically has an edge length greater than 1 micron.

Depending on the embodiment, within each micro mirror element the micro mirror surfaces may be modulated or varied in shape, curvature or slope.

It is preferred that the modulation of the micro mirror surfaces within each micro mirror element is designed to maximise the reflection efficiency of the reflected light from these elements at a particular distance from the device by means of a focussing of the reflected light at these distances. The modulation of the micro mirror surfaces within each micro mirror element may be described in terms of micro mirror surfaces shaped into a convex or concave form.

In one preferred embodiment, the micro mirror slopes of one of the two types of micro mirror elements are arranged to lie at right angles to the slopes of the micro mirror surfaces of a second group of micro mirror regions.

The primary pattern can be added in a number of different ways.

One way is to overlay a transparent film printed with the primary pattern file on top of the background MMA, the printed regions of the transparent screen being made opaque to reflected light by the printing process to thereby render reflected light optically ineffective.

Alternatively, the primary pattern may be printed directly on top of the background OVD MMA in order to make selected regions of the reflective background opaque or only partially transmitting to reflected light to thereby render them optically ineffective.

A further alternative technique is to use the laser ablation of selected micro mirror elements of the background MMA in order to make these regions non-reflecting or greatly reduced in the intensity of their reflected light, the distribution of the ablated regions being determined by the primary pattern.

The OVD MMA can also be embossed into a transfer foil and the transfer foil applied to the document to be protected by a hot stamping process or as a foil based label and such label being adhesively attached to the document requiring protection from counterfeiting.

Exemplary documents include a passport, visa, credit card, drivers license, a social security card, a banknote, cheque, share certificate or any other type of financial transaction document to protect the document against forgery or counterfeiting.

In addition to the BINAGRAM method for producing the primary pattern set out above the primary pattern may be produced according to the technique, known as “SAM” or “μ-SAM”, as described in U.S. Pat. No. 5,374,976 and by Sybrand Spannenberg in Chapter 8 of the book “Optical Document Security, Second Edition” (Editor: Rudolph L. van Renesse, Artech House, London, 1998, pages 169-199), or in the technique known as PHASEGRAM (Australian Provisional patent entitled “Method of Encoding a Latent Image”, Australian Provisional Patent number 2002952220 (23 Oct. 2002).

In this technique, an image is encoded within a locally periodic pattern by selectively modulating the periodicity of the pattern. When overlaid upon or overlaid with the original pattern on a transparent substrate, the latent image or various shades of its negative becomes visible to an observer depending on the exactness of the registration.

The periodicity of the image is modulated by phase-shifting image elements to create an encoded image. That is, different displacements are applied to image elements depending upon a value of a visual characteristic (e.g. a grey-scale value or a hue). A PHASEGRAM embodiment will typically utilise a secondary pattern where the micro-mirror elements are arrayed in columns of alternating types of micro-mirror elements N micro-mirror elements wide. This allows N+1 visual characteristic values to be encoded.

A latent image (the image which it is desired to be able to view) is formed by taking an original image and separating it into image elements which only take one of the set of allowable values of the visual characteristic. The latent image is then related to a preliminary primary pattern which has image elements corresponding to those of the secondary pattern. The image elements of the primary pattern are then displaced in accordance with their relationship with the value of the visual characteristic of the latent image elements with which they are related to form a final primary pattern which encodes the latent image.

Various different displacement schemes can be used. An example, is one where there are M shades or hues and image elements related to a first shade or hue are displaced by one image element (e.g. a distance corresponding to the width of a micro-mirror element), the second shade or hue is displaced by two image elements etc. with the M^{th} shade or hue displaced by M image elements.

Another technique which may be used to create a primary pattern from a secondary pattern is known as TONAGRAM and described in Australian Provisional Patent application 2004900187 entitled “Method of Concealing an Image” filed 17 Jan. 2004, which is incorporated herein by reference.

In this technique, an MDI, such as a BINAGRAM or a PHASEGRAM is mathematically combined with an overt image, such as a photographic portrait, to thereby render a primary pattern which contains both the overt image and one or more concealed latent images. When overlaid with the corresponding secondary pattern, the latent images are revealed. In the same way, a secondary pattern consisting of a micro mirror array of the type described in this application may be overlaid with a printed TONAGRAM primary pattern, thereby rendering an OVD containing an overt image which is visible at all angles of observation and which contains one or more latent images which are visible only at selected angles of observation. Alternatively, a blank canvas micro mirror array which serves as the secondary pattern may be rendered optically ineffective in selected areas according to a TONAGRAM algorithm. An OVD containing an overt image which is visible at all angles of observation and which contains one or more latent images which are visible only at selected angles of observation is thereby created.

A further alternative two-channel technique may involve encoding two separate but identical latent images which are observable at two slightly offset observation angles, the offset being chosen such that when observed by a human observer at an appropriate distance from the image surface, a stereoscopic effect allows the observer to perceive a three-dimensional image.

Thus, in a further embodiment it is possible to create a mask (e.g. a primary pattern) which encodes two identical images in such a manner that they are observable at offset observation angles when the mask overlays an appropriate secondary pattern, such as the secondary patterns disclosed herein.

In a two-channel case where the secondary pattern is shown in FIG. 1, the primary pattern may be produced by a technique where a positive tone version of an original image may fractured into a checkerboard pattern, and every alternate cell of the checkerboard (e.g. every “black” cell) is removed, and then a semi-transparent version of the image remainder is created by binary dithering or sampling techniques and the resultant fractured binary dithered version of the positive tone original image is overlaid by a second checkerboard fractured binary dithered image based on a negative tone image of the subject where in this case every inverse fractured checkerboard cell (e.g. every “white” cell) of the negative tone original image is removed to allow these areas to be occupied by the corresponding binary dithered (“black”) cells of the positive tone original image of the subject.

Various additional modifications will be apparent to person skilled in the art. For example, the background MMA may also include optically variable effects that are generic in nature and non-specific to the person, object or design that is being authenticated by the reflective device. Further, the MMA of the device may also incorporate extremely small scale images of size less than 60 microns in width and which can be used to provide a higher degree of authentication or security by means of microscopic examination of the MMA.

One advantage of the current MMA device over foil based OVD devices is provided by the fact that there is no requirement for hot stamping foil and this allows for much lower costs for applications requiring high volume production. This lower cost is achieved by having the MMA embossing process arranged in line with the various printing processes used to produce the particular document.

Further, embodiments of the present invention also offer much higher security over diffractive devices. This is due, in part, to complexity of the unique production processes required for the fabrication of the master MMA embossing/printing tools.

Reference may be made to International Patent Application No. PCT/AU02/00551 for further details as to how to construct an appropriate micro mirror array.

Persons skilled in the art will appreciate that various modifications can be made to the present invention without departing from the scope of the invention. These and other modifications will be apparent to those skilled in the art.

1. A method of forming a reflective device which generates an optically variable image which varies according to the angle of observation, the method comprising the steps of:
providing a primary pattern which encodes a latent image, the primary pattern having a plurality of image elements; and
providing a corresponding secondary pattern which will decode the primary pattern to allow the latent image to be observed when the primary and secondary patterns are in at least one registration, wherein the secondary pattern is provided by a micro mirror array (MMA) having a plurality of each of at least two different types of micro mirror elements,
wherein the primary pattern is provided such that predetermined image elements of the primary pattern render reflection effects from predetermined micro mirror elements of the MMA optically ineffective at least at one observation angle when the reflective device is illuminated with a light source to thereby enable the latent image to be observed.

2. A method as claimed in claim 1, comprising overlaying the primary pattern on the secondary pattern.

3. A method as claimed in claim 1, comprising rendering the micro mirror elements optically ineffective to form the primary pattern.

4. A method as claimed in claim 1, comprising printing the primary pattern on top of a background MMA.

5. A method as claimed in claim 1, comprising producing the micro mirror elements by:
I) producing a variable transparency photomask by electron beam lithography and wet or dry etching techniques and;
II) using the photomask in an optical contact printing or projection system to create a surface relief pattern of two types of interlaced micro mirror structures arranged in a desired pattern;
III) producing a printing plate embossing die by the use of electroplating techniques applied to the created micro mirror array structure; and
IV) applying ink to a paper or polymer substrate using screen printing techniques and embossing the micro mirror array structure into the inked substrate.

6. A method as claimed in claim 1, comprising providing said at least two types of micro mirror elements regions in a regular pattern.

7. A method as claimed in claim 6, comprising arranging said at least two types of micro mirror elements into pixellated diffraction grating regions.

8. A method as claimed in claim 6, comprising arranging said at least two types of micro mirror elements into a track-like pattern.

9. A method as claimed in claim 7, comprising arranging a plurality of two different types of micro mirror elements in a rectangular array so that they alternate in each of the horizontal and vertical axes.

10. A method as claimed in claim 2, comprising providing the primary pattern upon a transparent substrate, providing the secondary pattern in the form of an embossed substrate and aligning the primary pattern with the secondary pattern in correct register such that the image elements of the latent image render micro mirror elements of the secondary pattern optically ineffective.

11. A method as claimed in claim 2, comprising providing a MMA encoded with a secure generic optical variability effect, overlaying a primary pattern encoded with image information specific to a particular latent image in such a way that the latent image.

12. A method as claimed in claim 3, comprising altering the MMA at selected locations within the OVD area corresponding to the primary pattern, by laser heating the MMA.

13. A method as claimed in claim 1, comprising producing said primary pattern using a modulated digital image technique.

14. A method as claimed in claim 13, comprising selecting said technique from the group of SAM, P-SAM, PHASEGRAM, TONAGRAM and a BINAGRAM.

15. A reflective device which generates an optically variable image which varies according to the angle of observation, the reflective device comprising:
a primary pattern which encodes a latent image, the primary pattern having a plurality of image elements; and
a corresponding secondary pattern which will decode the primary pattern to allow the latent image to be observed when the primary and secondary patterns are in at least one registration, wherein the secondary pattern is provided by a micro mirror array (MMA) comprising a plurality of each of at least two different types of micro mirror elements, and
wherein the primary pattern is provided such that the predetermined image elements of the primary pattern render reflection effects from predetermined micro mirror elements of the MMA optically ineffective at least at one observation angle when the authentication device is illuminated with a light source to thereby enable the latent image to be observed.

16. A reflective device as claimed in claim 15, wherein said primary pattern is overlaid on the secondary pattern.

17. A reflective device as claimed in claim 15, wherein the primary pattern is provided by altering the MMA.

18. A reflective device as claimed in claim 15, wherein said primary pattern printed on top of a background MMA.

19. A reflective device as claimed in claim 15, wherein said at least two types of micro mirror elements form a regular pattern.

20. A reflective device as claimed in claim 19, wherein said regular pattern is a pixellated pattern.

21. A reflective device as claimed in claim 19, wherein said regular pattern is a track-like pattern.

22. A reflective device as claimed in claim 20, wherein a plurality of two different types of micro mirror elements are arranged in a rectangular array so that they alternate in each of the horizontal and vertical axes to thereby form a checkerboard pattern.

23. A reflective device as claimed in claim 15, comprising two different types of micro mirror elements.

24. A reflective device as claimed in claim 15, wherein the primary pattern is provided upon a transparent substrate, and the secondary pattern is an embossed substrate (OVD), the primary pattern being aligned with the OVD secondary pattern in correct register such that the image elements of the latent image encoded in the primary pattern are observable as having different visual values at certain viewing angles when illuminated with a light source.

25. A reflective device as claimed in claim 24, wherein the image elements are transparent and opaque.

26. A reflective device as claimed in claim 24, wherein the image elements are transparent or coloured

27. A reflective device as claimed in claim 24, wherein the embossed substrate is encoded to produce a secure generic optical variability effect and the overlaid primary pattern is encoded with image information specific to a particular latent image.

28. A reflective device as claimed in claim 17, wherein the MMA is altered at selected locations within the primary pattern, by heating the MMA.

29. A reflective device as claimed in claim 20, incorporating a photosensitive layer above an embossed layer which provides the secondary pattern, whereby the primary pattern can be printed by selective irradiation of the photosensitive layer.

30. A reflective device as claimed in claim 15, wherein said primary pattern comprises a modulated digital image.

31. A reflective device as claimed in claim 30, wherein said modulated digital image is one of a SAM image, μ-SAM image, a PHASEGRAM, a TONAGRAM or a BINAGRAM.

32. A reflective device as claimed in claim 15, which constitutes a reflective authentication device.

33. A reflective device as claimed in claim 15, which constitutes a novelty item.

34. A document or instrument incorporating a diffractive device as claimed in claim 15.

35. A reflective device as claimed in claim 18, wherein the primary and secondary patterns are constructed such that a first image is observable at least a first angle of view and a second image is observed at least a second angle of view.

36. A reflective device as claimed in claim 35, wherein said first image is an image of a person.

37. A reflective device as claimed in claim 36, wherein said second image is an image of a logo, a coat of arms or the like.

38. A diffractive device as claimed in claim 38, wherein said second image encodes data.

39. A diffractive device as claimed in claim 38, wherein said second image is a bar code.

40. A diffractive device as claimed in claim 35, wherein both the first and second images encode data.

41. A diffractive device as claimed in claim 40, wherein both the first and second images are bar codes.
